(19) United States
(12) Patent Application Publication
(10) Pub. No.: US 2019/0218719 A1
(43) Pub. Date: Jul. 18, 2019

(54) COATING COMPOSITIONS AND ASSOCIATED PAPERBOARD STRUCTURES

(71) Applicant: WestRock MWV, LLC, Atlanta, GA (US)

(72) Inventors: Steven G. Bushhouse, Quinton, VA (US); Gary P. Fugitt, Rockville, VA (US); Scott E. Ginther, Moseley, VA (US)

(21) Appl. No.: 16/238,903

(22) Filed: Jan. 3, 2019

Related U.S. Application Data
(60) Provisional application No. 62/616,686, filed on Jan. 12, 2018.

(51) Int. Cl. D21H 19/12; C09D 7/41; C09D 7/62; C09D 125/14; C09D 133/06; C09D 103/02; C09D 7/40; D21H 19/82; D21H 17/00; D21H 17/68; D21H 17/67; D21H 17/69; D21H 17/37; D21H 17/28

(52) U.S. Cl. CPC D21H 19/12; C09D 7/41; C09D 7/62; C09D 125/14; C09D 133/062; C09D 103/02; D21H 17/28; D21H 19/82; D21H 17/74; D21H 17/68; D21H 17/675; D21H 17/69; D21H 17/37; C09D 7/70

(57) ABSTRACT

A coating composition for paperboard including a binder and a pigment blend including a low density organic pigment and a modified inorganic pigment.

### PRIORITY

This application claims priority from U.S. Ser. No. 62/616,686 filed on Jan. 12, 2018, the entire contents of which are incorporated herein by reference.

### FIELD

This application relates to coating compositions for paperboard and, more particularly, to the use of low density organic pigments in combination with engineered inorganic pigments to form paperboard coating compositions.

### BACKGROUND

Paperboard is used in a wide variety of applications. In certain applications, such as packaging, it is often desired to use a paperboard with a smooth and printable surface. Paperboard with a smooth and printable surface can facilitate the printing of high-quality text and graphics, thereby significantly increasing the visual appeal of products packaged in paperboard.

To achieve smoothness and printability, paperboard is often coated with various coating compositions. For example, a basecoat containing traditional pigments and binder is commonly applied to the surface of paperboard. The basecoat is then overcoated with a second coating (and sometimes even a third coating), thereby forming a top coat over the basecoat.

Smoothness and printability depend on the compositions of the coatings applied to the surface of the paperboard, as well as the quantity of pigments used in those compositions. In general, the more pigment used in a paperboard coating composition, the greater the smoothness. However, as the quantity of pigment increases, so too does the cost of manufacture. While efforts have been made to engineer coating compositions that offer increased smoothness with less pigment, the increased cost of such compositions can offset the cost savings associated with using less overall pigment.

Accordingly, those skilled in the art continue with research and development efforts in the field of paperboard coating compositions.

### SUMMARY

In one embodiment, the disclosed coating composition includes a binder and a pigment blend including a low density organic pigment and a modified inorganic pigment.

In another embodiment, the disclosed coating composition includes a binder and a pigment blend including a low density organic pigment and at least one of a modified clay and a modified calcium carbonate.

In one embodiment, the disclosed paperboard structure includes a paperboard substrate, a basecoat and a top coat, wherein the basecoat is positioned between the paperboard substrate and the top coat, and wherein the basecoat comprises a binder and a pigment blend including a low density organic pigment and a modified inorganic pigment.

In another embodiment, the disclosed paperboard structure includes a paperboard substrate and a single-coat layer applied to the paperboard substrate, wherein the single-coat layer comprises a binder and a pigment blend including a low density organic pigment and a modified inorganic pigment.

Other embodiments of the disclosed coating compositions and associated paperboard structures will become apparent from the following detailed description, the accompanying drawings and the appended claims.

### BRIEF DESCRIPTION OF THE DRAWINGS

FIG. 1 is a schematic block diagram of an embodiment of the disclosed coating composition;

FIG. 2 is a graphical representation of the particle size distribution of a commercially-available delaminated clay compared to the particle size distribution of a modified clay suitable for use in the coating composition of FIG. 1;

FIG. 3 is a graphical representation of the particle size distribution of a commercially-available coarse calcium carbonate compared to the particle size distribution of a modified calcium carbonate suitable for use in the coating composition of FIG. 1;

FIG. 4 is a cross-sectional view of one (multi-coat) embodiment of a paperboard structure manufactured using the coating composition of FIG. 1;

FIG. 5 is a cross-sectional view of another (single-coat) embodiment of a paperboard structure manufactured using the coating composition of FIG. 1;

FIG. 6 is a graphical representation of the void volumes of pigment blends of the disclosed coating compositions as a function of quantity of low density organic pigment present;

FIG. 7 is a graphical representation of Parker Print Surface (PPS 10S) smoothness versus coat weight for calendered, single-coated paperboard structures, including two examples using the disclosed coating compositions formulated with modified clay and two comparative examples;

FIG. 8 is a graphical representation of Parker Print Surface (PPS 10S) smoothness versus coat weight for basecoated paperboard structures, including two examples using the disclosed coating compositions formulated with modified clay and two comparative examples;

FIG. 9 is a graphical representation of Parker Print Surface (PPS 10S) smoothness versus basecoat weight for uncalendered, topcoated paperboard structures, including two examples using the disclosed coating compositions formulated with modified clay and two comparative examples;

FIG. 10 is a graphical representation of Parker Print Surface (PPS 10S) smoothness versus coat weight for calendered, single-coated paperboard structures, including two examples using the disclosed coating compositions formulated with modified calcium carbonate and two comparative examples;

FIG. 11 is a graphical representation of Parker Print Surface (PPS 10S) smoothness versus coat weight for basecoated paperboard structures, including two examples using the disclosed coating compositions formulated with modified calcium carbonate and two comparative examples; and

FIG. 12 is a graphical representation of Parker Print Surface (PPS 10S) smoothness versus basecoat weight for topcoated paperboard structures, including two examples using the disclosed coating compositions formulated with modified calcium carbonate and two comparative examples.

### DETAILED DESCRIPTION

Disclosed are coating compositions and paperboard structures manufactured using the disclosed coating compositions. Various methods are also disclosed.

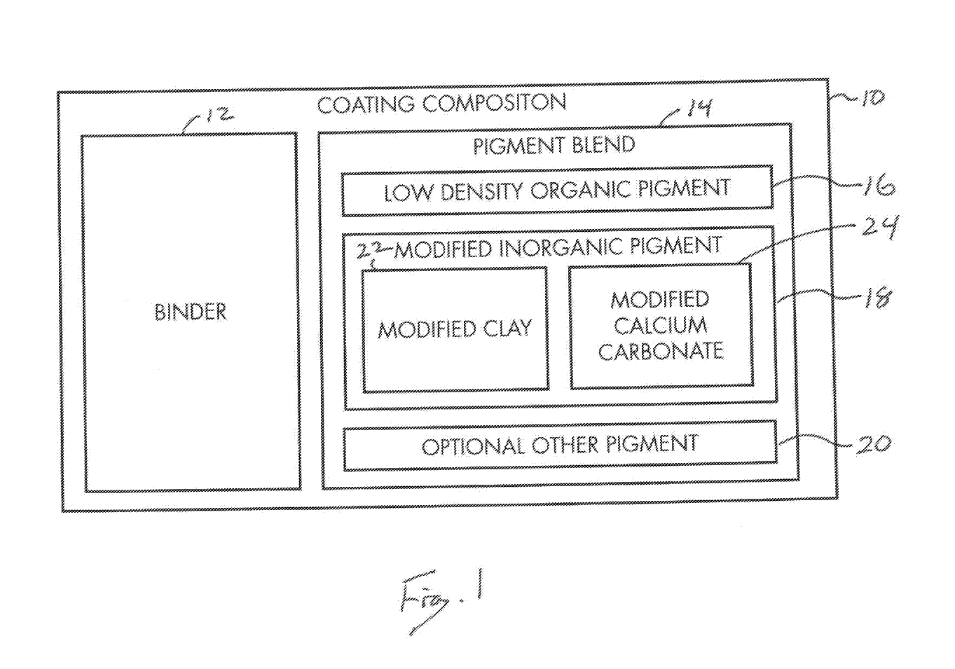

Referring to FIG. 1, an embodiment of the disclosed coating composition, generally designated 10, includes a binder 12 and a pigment blend 14. The pigment blend 14 includes a low density organic pigment 16, a modified inorganic pigment 18 and, optionally, one or more other pigments 20. In one variation, the modified inorganic pigment 18 may be modified clay 22. In another variation, the modified inorganic pigment 18 may be modified calcium carbonate 24. In yet another variation, the modified inorganic pigment 18 may include both modified clay 22 and modified calcium carbonate 24.

Various materials may be used as the binder 12 of the coating composition 10 without departing from the scope of the present disclosure. Those skilled in the art will appreciate that the composition of the binder 12 is a design consideration, and that selection of the composition of the binder 12 is well within the capabilities of a person of ordinary skill in the art.

In one particular implementation, the binder 12 of the disclosed coating composition 10 may be latex. One specific, non-limiting example of a suitable latex binder is ACRONAL® S504, a styrene acrylic latex commercially available from BASF Corporation of Florham Park, N.J. Another specific, non-limiting example of a suitable latex binder is BASANOL X497AB, a styrene acrylate latex from BASF Corporation.

In another particular implementation, the binder 12 of the disclosed coating composition 10 may be starch. One specific, non-limiting example of a suitable starch binder is ETHYLEX® 2015, an ethylated starch commercially available from Tate & Lyle of London, United Kingdom.

Those skilled in the art will appreciate that the quantity of binder 12 used in the coating composition 10 is a design consideration, and that selection of an appropriate quantity of binder 12 is well within the capabilities of a person of ordinary skill in the art. For example, and without limitation, the binder 12 may be present in the coating composition 10 at a quantity of about 5 to about 50 parts by weight (e.g., 20 parts) binder 12 per 100 parts by weight of the pigment blend 14.

The low density organic pigment 16 of the pigment blend 14 of the disclosed coating composition 10 may be any polymer-based pigment that is hollow (e.g., includes one or more voids), but which does not expand more than 10 percent by volume when heated. For example, the low density organic pigment 16 may be hollow spheres formed from a polymeric material, wherein the hollow spheres are sufficiently permeable to air and water vapor such that they do not significantly expand when heated (i.e., they expand by at most 10 percent by volume).

Because the low density organic pigment 16 is polymer-based and contains voids, the low density organic pigment 16 has a significantly lower density as comparted to traditional inorganic pigments (e.g., clay and calcium carbonate). In one expression, the low density organic pigment 16 may have a density of at most 1.04 g/cm³. In another expression, the low density organic pigment 16 may have a density of at most 0.9 g/cm³. In another expression, the low density organic pigment 16 may have a density of at most 0.8 g/cm³. In another expression, the low density organic pigment 16 may have a density of at most 0.7 g/cm³. In yet another expression, the low density organic pigment 16 may have a density of at most 0.6 g/cm³.

Various pigments may be used as the disclosed low density organic pigment 16. As one specific non-limiting example, the low density organic pigment 16 may be ROPAQUE™ AF-500 EF, which is a low density organic pigment having an average diameter of about 0.4 μm that is commercially available from The Dow Chemical Company of Midland, Mich. As another specific non-limiting example, the low density organic pigment 16 may be ROPAQUE™ OP-96, which is a low density organic pigment having an average diameter of about 0.6 μm that is commercially available from The Dow Chemical Company. As another specific non-limiting example, the low density organic pigment 16 may be ROPAQUE™ AF-1055, which is a low density organic pigment having an average diameter of about 1.0 μm that is commercially available from The Dow Chemical Company. As another specific non-limiting example, the low density organic pigment 16 may be ROPAQUE™ AF-1353, which is a low density organic pigment having an average diameter of about 1.3 μm that is commercially available from The Dow Chemical Company. As yet another specific non-limiting example, the low density organic pigment 16 may be ROPAQUE™ TH-2000AF, which is a low density organic pigment having an average diameter of about 1.5 μm that is commercially available from The Dow Chemical Company.

The low density organic pigment 16 may be present in the pigment blend 14 at a quantity sufficient to beneficially increase the void volume of the pigment blend 14. In one expression, the low density organic pigment 16 may be present in the pigment blend 14 at a concentration of at least 10 percent by volume. In another expression, the low density organic pigment 16 may be present in the pigment blend 14 at a concentration of at least 15 percent by volume. In another expression, the low density organic pigment 16 may be present in the pigment blend 14 at a concentration of at least 20 percent by volume. In another expression, the low density organic pigment 16 may be present in the pigment blend 14 at a concentration of at least 25 percent by volume. In another expression, the low density organic pigment 16 may be present in the pigment blend 14 at a concentration ranging from about 10 percent by volume to about 80 percent by volume. In another expression, the low density organic pigment 16 may be present in the pigment blend 14 at a concentration ranging from about 15 percent by volume to about 65 percent by volume. In another expression, the low density organic pigment 16 may be present in the pigment blend 14 at a concentration ranging from about 20 percent by volume to about 60 percent by volume. In yet another expression, the low density organic pigment 16 may be present in the pigment blend 14 at a concentration ranging from about 25 percent by volume to about 50 percent by volume.

In addition to the low density organic pigment 16, the pigment blend 14 may further include the modified inorganic pigment 18 and optionally, one or more other pigments 20. The modified inorganic pigment 18 may include modified clay 22, modified calcium carbonate 24, or various combinations of modified clay 22 and modified calcium carbonate 24. The optional other pigment 20 may be an inorganic pigment (e.g., an unmodified inorganic pigment).

The modified inorganic pigment 18 of the pigment blend 14 of the disclosed coating composition 10 is an inorganic pigment that has been processed or otherwise (e.g., naturally occurring) has a particle size distribution with a relatively low quantity of fines (e.g., particles having a particle size less than 1 μm). That is to say, the modified inorganic pigment 18 is an inorganic pigment having a controlled quantity of particles having a particle size of 1 μm or less.

As used herein, a clay pigment is deemed a “modified clay 22” when at most 30 percent of the particles of the clay pigment have a particle size less than 1 μm. In one expression, at most 25 percent of the particles of the modified clay 22 have a particle size less than 1 μm. In another expression, at most 20 percent of the particles of the modified clay 22 have a particle size less than 1 μm. In another expression, at most 18 percent of the particles of the modified clay 22 have a particle size less than 1 μm. In yet another expression, at most 15 percent of the particles of the modified clay 22 have a particle size less than 1 μm.

Various clay pigments may be used as, or processed to yield, a modified clay 22. As one general, non-limiting example, the modified clay 22 may be a kaolin clay, such as a delaminated kaolin clay. As one specific, non-limiting example, the modified clay 22 may be obtained by removing fines from HYDRAPRINT® kaolin clay, which is commercially available from KaMin LLC of Macon, Ga.

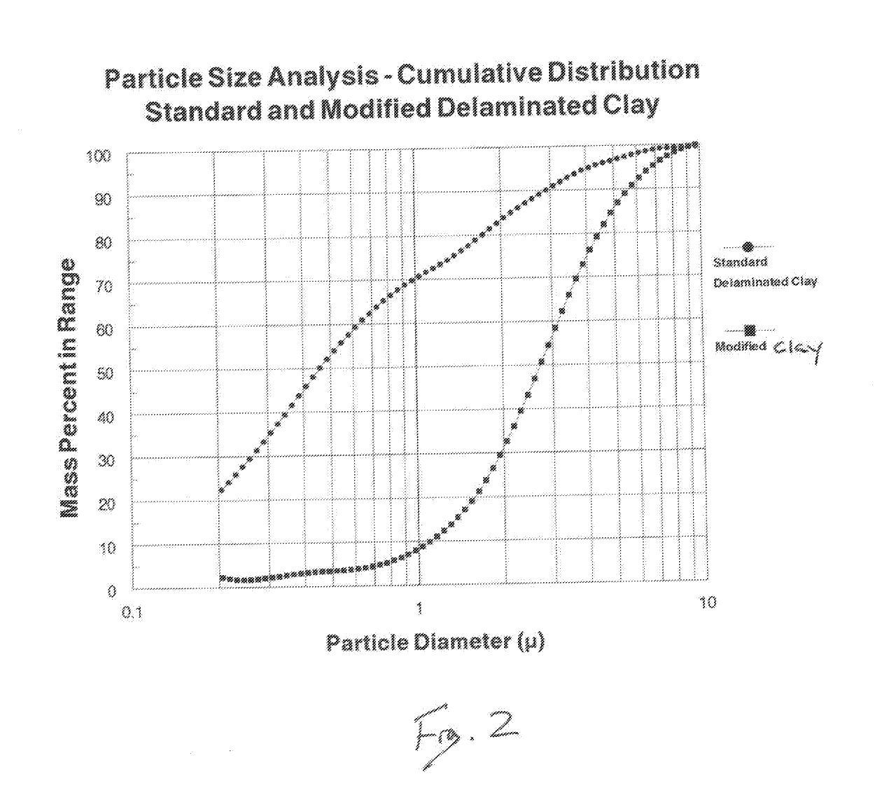

FIG. 2 graphically presents the particle size distribution of standard HYDRAPRINT® kaolin clay as compared to the modified clay 22 (FIG. 1) obtained by removing fines from HYDRAPRINT® kaolin clay. These measurements were made using a SEDIGRAPH® 5120 particle size analyzer, which is commercially available from Micromeritics Instrument Corporation of Norcross, Ga. The data in FIG. 2 is expressed as a cumulative mass percent less than a given particle size. By identifying the point at which the curves intersect with 1 μm on the x-axis, one can see that the standard HYDRAPRINT® kaolin clay has about 70 percent of particles less than 1 μm, while the modified clay 22 only has about 8 percent of particles less than 1 μm. Furthermore, HYDRAPRINT® kaolin clay has about 83 percent of particles less than 2 μm, while the modified clay 22 about 32 percent of particles less than 2 μm.

Modified clay 22 suitable for use in (or as) the pigment blend 14 of the disclosed coating composition 10 is also disclosed in U.S. Ser. No. 62/616,094 filed on Jan. 11, 2018, the entire contents of which are incorporated herein by reference.

As used herein, a calcium carbonate pigment is deemed a “modified calcium carbonate 24” when particles of the calcium carbonate pigment have a median particle size between about 3 μm and about 8 μm, and when at most 15 percent of the particles of the calcium carbonate pigment have a particle size less than 1 μm. In one expression, at most 13 percent of the particles of the modified calcium carbonate 24 have a particle size less than 1 μm. In another expression, at most 12 percent of the particles of the modified calcium carbonate 24 have a particle size less than 1 μm. In another expression, at most 10 percent of the particles of the modified calcium carbonate 24 have a particle size less than 1 μm. In yet another expression, at most 8 percent of the particles of the modified calcium carbonate 24 have a particle size less than 1 μm.

Various calcium carbonate pigments may be used as, or processed to yield, a modified calcium carbonate 24. As one general, non-limiting example, the modified calcium carbonate 24 may be a ground calcium carbonate. As another general, non-limiting example, the modified calcium carbonate 24 may be a coarse ground calcium carbonate. As one specific, non-limiting example, the modified calcium carbonate 24 may be obtained by removing fines from HYDROCARB® 60 ground calcium carbonate, which is commercially available from Omya AG of Oftringen, Switzerland.

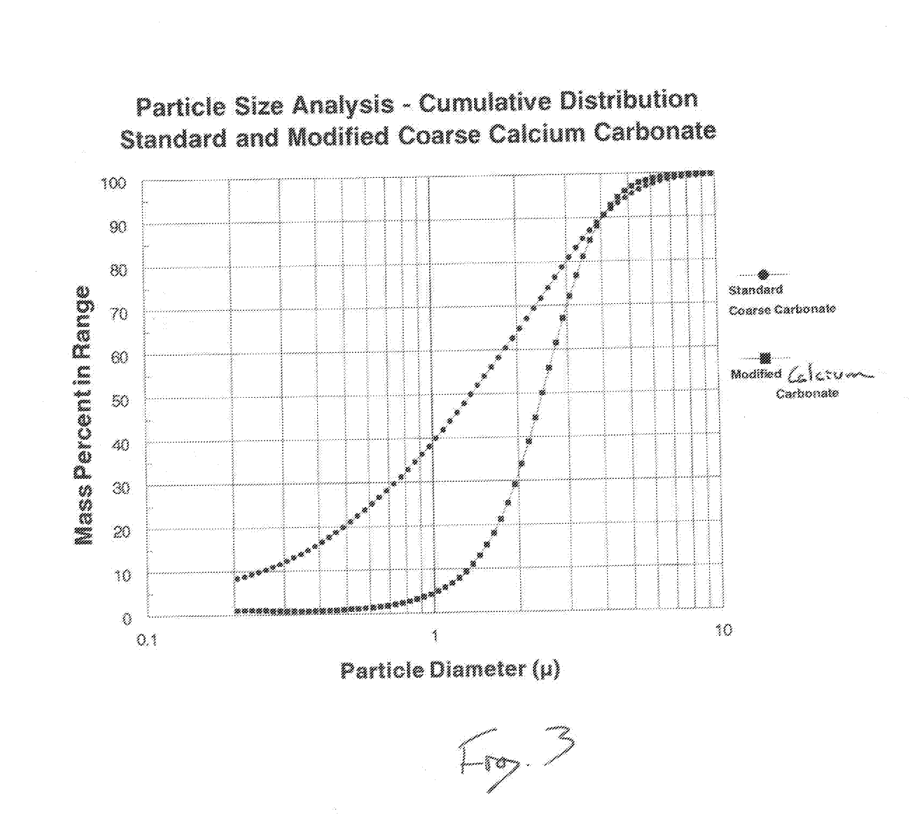

FIG. 3 graphically presents the particle size distribution of standard HYDROCARB® 60 ground calcium carbonate as compared to the modified calcium carbonate 24 (FIG. 1) obtained by removing fines from HYDROCARB® 60 ground calcium carbonate. These measurements were made using a SEDIGRAPH® 5120 particle size analyzer, which is commercially available from Micromeritics Instrument Corporation of Norcross, Ga. The data in FIG. 3 is expressed as a cumulative mass percent less than a given particle size. By identifying the point at which the curves intersect with 1 μm on the x-axis, one can see that the standard HYDROCARB® 60 ground calcium carbonate has about 39 percent of particles less than 1 μm, while the modified calcium carbonate 24 only has about 5 percent of particles less than 1 μm. Furthermore, HYDROCARB® 60 ground calcium carbonate has about 64 percent of particles less than 2 μm, while the modified calcium carbonate 24 about 32 percent of particles less than 2 μm.

Modified calcium carbonate 24 suitable for use in (or as) the pigment blend 14 of the disclosed coating composition 10 is also disclosed in U.S. Pat. No. 8,916,636 issued on Dec. 23, 2014, to Bushhouse et al., the entire contents of which are incorporated herein by reference.

The pigment blend 14 of the disclosed coating composition 10 has a relatively high void volume, particularly as compared to void volumes of traditional inorganic pigments and blends of traditional inorganic pigments with organic pigments. In one expression, pigment blend 14 has a void volume of at least 40 percent. In another expression, the pigment blend 14 has a void volume of at least 45 percent. In another expression, the pigment blend 14 has a void volume of at least 50 percent. In another expression, the pigment blend 14 has a void volume of at least 55 percent. In yet another expression, the pigment blend 14 has a void volume of at least 60 percent.

Without being limited to any particular theory, it is presently believed that when the coating composition 10 is applied to a paperboard substrate, the resulting paperboard structure exhibits improved smoothness and surface coverage due to the relatively high void volume of the pigment blend 14. Significantly, such improved smoothness can be achieved without the use of expensive high aspect ratio clays.

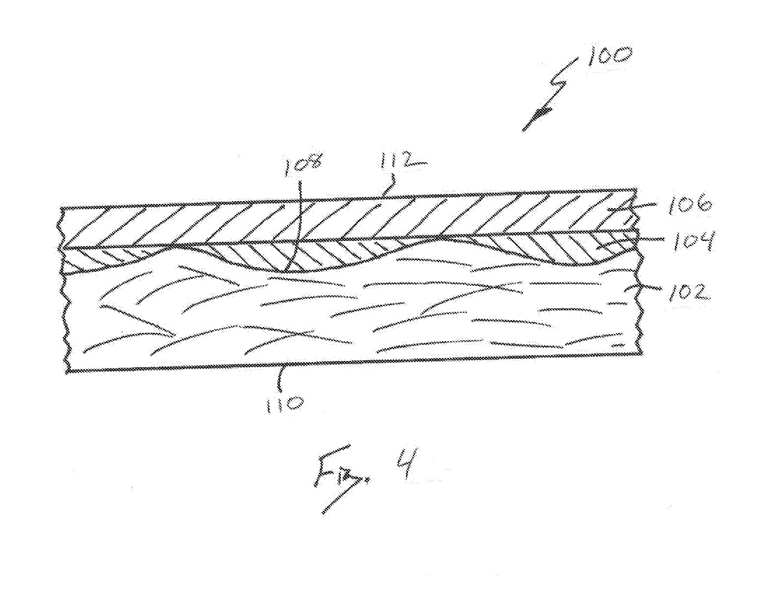

Referring to FIG. 4, one embodiment of the disclosed paperboard structure, generally designated 100, may include a paperboard substrate 102, a basecoat 104 and a top coat 106. Additional coating layers may optionally be included between the basecoat 104 and the top coat 106 without departing from the scope of the present disclosure. The paperboard substrate 102 may include a first major surface 108 and a second major surface 110. The basecoat 104 may be applied only to the first major surface 108 (C1S) or to both the first major surface 108 and the second major surface 110 (C2S). The top coat 106 may be applied over the basecoat 104 to present an outermost coating surface 112.

The paperboard substrate 102 of the paperboard structure 100 may be any web of fibrous material that is capable of being coated with the disclosed basecoat 14. The paperboard substrate 102 may be bleached or unbleached, and may be paper or thicker and more rigid than paper. For example, the paperboard substrate 102 may have an uncoated basis weight of about 85 pounds per 3000 ft² or more. Examples of appropriate paperboard substrates 102 include corrugating medium, linerboard, solid bleached sulfate (SBS) and aseptic liquid packaging paperboard.

The basecoat 104 of the paperboard structure 100 may be formed by applying the disclosed coating composition 10 (FIG. 1) to the first major surface 108 of the paperboard substrate 102.

In one particular implementation, the basecoat 104 may be applied to the first major surface 108 of the paperboard substrate 102 in a quantity sufficient to fill the pits and crevices in the first major surface 108 without the need for coating the entire first major surface 108 of the paperboard substrate 102, thereby forming a discontinuous film on the first major surface 108. For example, the basecoat 104 may be applied using a blade coater such that the blade coater urges the basecoat 104 into the pits and crevices in the first major surface 108 while removing the basecoat 104 from the first major surface 108. Specifically, the basecoat 104 may be applied in a manner that is akin to spackling, wherein substantially all of the basecoat 104 resides in the pits and crevices in the first major surface 108 of the paperboard substrate 102 rather than on the first major surface 108 of the paperboard substrate 102.

At this point, those skilled in the art will appreciate that when the basecoat 104 is used in a blade coater, the spacing between the moving paperboard substrate 102 and the blade of the coater may be minimized to facilitate filling the pits and crevices in the first major surface 108 without substantially depositing the basecoat 104 on the first major surface 108 of the paperboard substrate 102 (i.e., forming a discontinuous film on the first major surface 108 of the paperboard substrate 102). In other words, the blade of the coater may be positioned sufficiently close to the first major surface 108 of the moving paperboard substrate 102 such that the blade of the coater urges the basecoat 104 into the pits and crevices in the first major surface 108 of the paperboard substrate 102, while removing excess basecoat 104 from the first major surface 108 of the paperboard substrate 102.

The top coat 106 may be any appropriate topcoat. For example, the topcoat 106 may include calcium carbonate, clay and various other components and may be applied over the basecoat 104 as a slurry. Top coats are well known by those skilled in the art and any conventional or non-conventional top coat composition may be used without departing from the scope of the present disclosure.

The outermost coating surface 112 of the disclosed paperboard structure 100 may be relatively smooth. In one realization, the outermost coating surface 112 of the disclosed paperboard structure 100 may have a Parker Print Surface (PPS 10S) smoothness of at most about 5 micrometers. In another realization, the outermost coating surface 112 of the disclosed paperboard structure 100 may have a Parker Print Surface (PPS 10S) smoothness of at most about 4 micrometers. In another realization, the outermost coating surface 112 of the disclosed paperboard structure 100 may have a Parker Print Surface (PPS 10S) smoothness of at most about 3 micrometers. In another realization, the outermost coating surface 112 of the disclosed paperboard structure 100 may have a Parker Print Surface (PPS 10S) smoothness of at most about 2 micrometers.

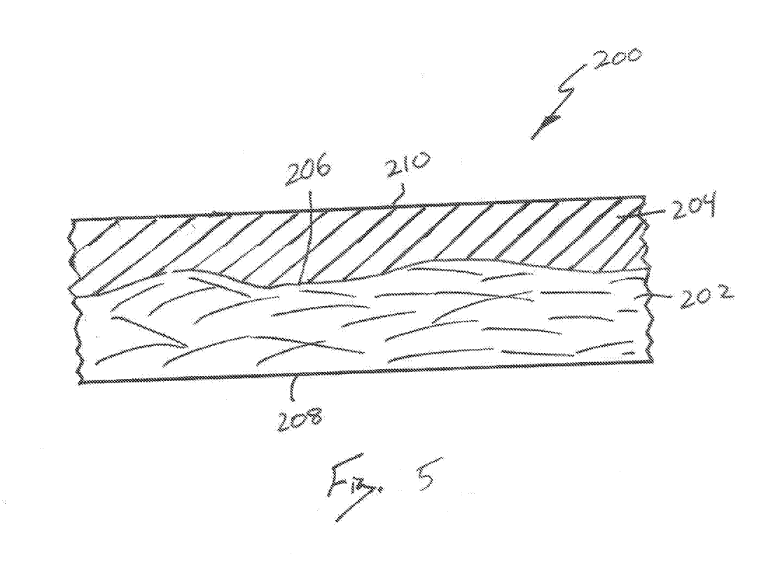

Referring to FIG. 5, another embodiment of the disclosed paperboard structure, generally designated 200, may include a paperboard substrate 202 and a single-coat layer 204 applied to the paperboard substrate 202. The paperboard substrate 202 may include a first major surface 206 and a second major surface 208. The single-coat layer 204 may be applied only to the first major surface 206 (C1S), as shown in FIG. 5, or to both the first major surface 206 and the second major surface 208 (C2S) (not shown). Therefore, the single-coat layer 204 may be in direct contact the paperboard substrate 202 (e.g., the first major surface 206 of the paperboard substrate 202), while also forming the outermost coating surface 210 of the paperboard structure 200.

The paperboard substrate 202 of the paperboard structure 200 may be any web of fibrous material that is capable of being coated with the single-coat layer 204. The paperboard substrate 202 may be bleached or unbleached, and may be paper or thicker and more rigid than paper. For example, the paperboard substrate 202 may have an uncoated basis weight of about 85 pounds per 3000 ft² or more. Examples of appropriate paperboard substrates 202 include corrugating medium, linerboard, solid bleached sulfate (SBS) and aseptic liquid packaging paperboard.

The single-coat layer 204 of the paperboard structure 200 may be formed by applying the disclosed coating composition 10 (FIG. 1) to the first major surface 206 of the paperboard substrate 202.

The outermost coating surface 210 of the disclosed paperboard structure 200 may be relatively smooth, which has been difficult to achieve using a single-coat layer. In one realization, the outermost coating surface 210 of the disclosed paperboard structure 200 may have a Parker Print Surface (PPS 10S) smoothness of at most about 5 micrometers. In another realization, the outermost coating surface 210 of the disclosed paperboard structure 200 may have a Parker Print Surface (PPS 10S) smoothness of at most about 4 micrometers. In another realization, the outermost coating surface 210 of the disclosed paperboard structure 200 may have a Parker Print Surface (PPS 10S) smoothness of at most about 3 micrometers. In another realization, the outermost coating surface 210 of the disclosed paperboard structure 200 may have a Parker Print Surface (PPS 10S) smoothness of at most about 2 micrometers.

The single-coat layer 204 of the disclosed paperboard structure 200 may have a relatively low dry weight, while still providing desired smoothness. In one expression, the single-coat layer 204 may have a dry weight of at most about 10 lb/3000 ft². In another expression, the single-coat layer 204 may have a dry weight of at most about 9 lb/3000 ft². In yet another expression, the single-coat layer 204 may have a dry weight of at most about 8 lb/3000 ft².

### EXAMPLES

### Example 1

Experiments were performed to measure the void volumes of various pigment blends containing low density organic pigments. Because of the density differences between low density organic pigments and inorganic pigments, a method other than sedimentation had to be used. A method was devised using the absorption of mineral oil into layers of pigment blends to measure the void volume within packed pigments. All pigment blends were formulated based on volume. Because the films needed to maintain their integrity when oil was applied, a controlled volume of latex binder was added to each blend.

The experimental method was as follows. Formulations containing various pigment blends were prepared and applied to Mylar film using a Byrd bar with a 10 mil gap. Each film was air dried, then placed in an oven at 160° F. for 20 minutes. A die cutter was used to cut a 3 inch-by-6 inch area from both the coated and uncoated portions of the Mylar. These coupons were weighed to determine the weight of coating applied. The coated coupon was then saturated with mineral oil, then the excess was wiped away. The oil-saturated coupon was then weighed to determine the amount of oil picked up. The void volume was calculated using the formulation, the weights, the densities of the components and the density of the oil. Because the formulations included 8 percent binder (to maintain integrity), the volume of the binder was considered when calculating final void volume value. The results are provided in Table 1.

TABLE 1

| | Modified | | | | | |
|---|---|---|---|---|---|---|
| | (Delaminated) | Modified (Coarse) | Low Density | Styrene Acrylic | Average Void | Standard |
| | Clay | Calcium Carbonate | Organic Pigment | Latex | Volume (3 reps) | Deviation |
| | Parts Volume | Parts Volume | Parts Volume | Parts Volume | % | % |
| 1 | 100 | | 0 | 8 | 51.42 | 0.39 |
| 2 | 85 | | 15 | 8 | 51.36 | 0.63 |
| 3 | 70 | | 30 | 8 | 54.71 | 0.51 |
| 4 | 55 | | 45 | 8 | 59.00 | 0.02 |
| 5 | 40 | | 60 | 8 | 63.30 | 0.12 |
| 6 | | 100 | 0 | 8 | 39.18 | 0.70 |
| 7 | | 85 | 15 | 8 | 41.39 | 0.41 |
| 8 | | 70 | 30 | 8 | 45.42 | 0.41 |
| 9 | | 55 | 45 | 8 | 51.14 | 0.35 |
| 10 | | 40 | 60 | 8 | 58.10 | 0.07 |

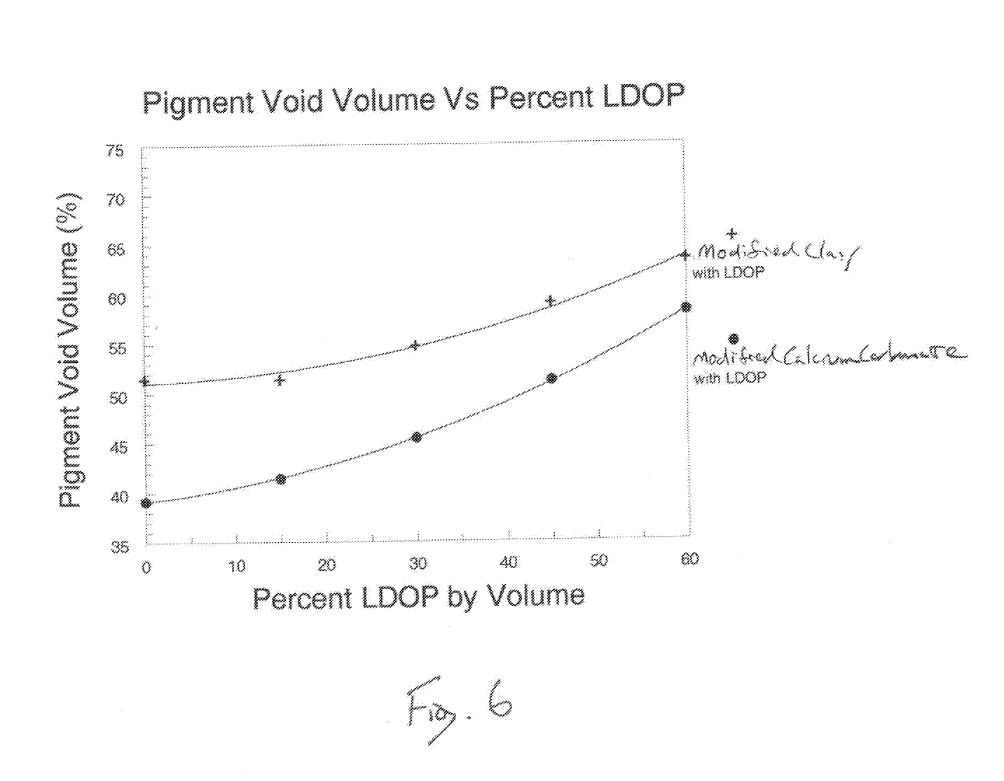

FIG. 6 shows the effects of the low density organic pigment level when blended with a modified clay or a modified calcium carbonate. This demonstrates that combinations of modified clay/modified calcium carbonate with low density organic pigment yield void volumes that equal or exceed the void volumes achieved using hyperplaty clay.

### Example 2

Coatings compositions containing modified clay and low density organic pigment were prepared and applied as a single-coat layer to a solid bleached sulfate (SBS) paperboard substrate (caliper: 11 pt; basis weight: 114 lb/3000 ft²). The coating compositions were applied to a 1 ft-wide web of the paperboard substrate at 1000 fpm using a bent blade configuration on a pilot coater, thereby obtaining coated samples with a series of coat weights. The coating compositions are presented in Table 2.

TABLE 2

| Parts by Weight | M1 | M2 | M3 | M4 |
|---|---|---|---|---|
| HYDRAPRINT ® | 50 | | | |
| Modified HYDRAPRINT ® | | 50 | 50 | 50 |
| ROPAQUE ™ 1353 | | | 5.8 | 15.7 |
| HYDROCARB ® 60 | 50 | 50 | 44.2 | 34.3 |
| ACRONAL ® S 504 | 20 | 20 | 20 | 20 |
| Parts by Volume | M1 | M2 | M3 | M4 |
| HYDRAPRINT ® | 50 | | | |
| Modified HYDRAPRINT ® | | 50 | 39.8 | 29.7 |
| ROPAQUE ™ 1353 | | | 25 | 50 |
| HYDROCARB ® 60 | 50 | 50 | 35.2 | 20.3 |

All coating compositions were formulated using 50 parts clay, by weight. A standard delaminated clay, HYDRAPRINT® kaolin clay from KaMin LLC, was used as a reference to the modified clay (a processed version of HYDRAPRINT® kaolin clay; see FIG. 2). A coarse ground calcium carbonate (“GCC”), HYDROCARB® 60 from Omya, was used as well as ROPAQUE™ 1353 from The Dow Chemical Company, as the low density organic pigment. The low density organic pigment was added to the modified clay at levels representing 25 and 50 percent by volume. All formulations had 20 parts of ACRONAL® S504, a styrene acrylic latex, as binder.

Handsheets of coated board samples were supercalendered. The coat weights and the calendered PPS smoothness data is recorded in Table 3.

TABLE 3

| | | Coat | Calendered | |
|---|---|---|---|---|
| | | Weight | PPS | |
| | | lb/3000 | Smoothness | Std. |
| | | ft² | (μm) | dev. |
| M1 | HYDRAPRINT ® | 5.5 | 4.80 | 0.11 |
| | | 6.8 | 4.28 | 0.09 |
| | | 8.3 | 4.01 | 0.12 |
| M2 | Modified | 5.8 | 3.72 | 0.16 |
| | HYDRAPRINT ® | 6.8 | 3.20 | 0.13 |
| | | 7.9 | 2.86 | 0.10 |
| M3 | Modified | 5.8 | 3.02 | 0.08 |
| | HYDRAPRINT ® | 7.1 | 2.53 | 0.10 |
| | w/25 parts by Vol. | 8.3 | 2.35 | 0.13 |
| M4 | Modified | 5.9 | 2.59 | 0.12 |
| | HYDRAPRINT ® | 6.5 | 2.38 | 0.14 |
| | w/50 parts by Vol. | 7.9 | 2.18 | 0.11 |

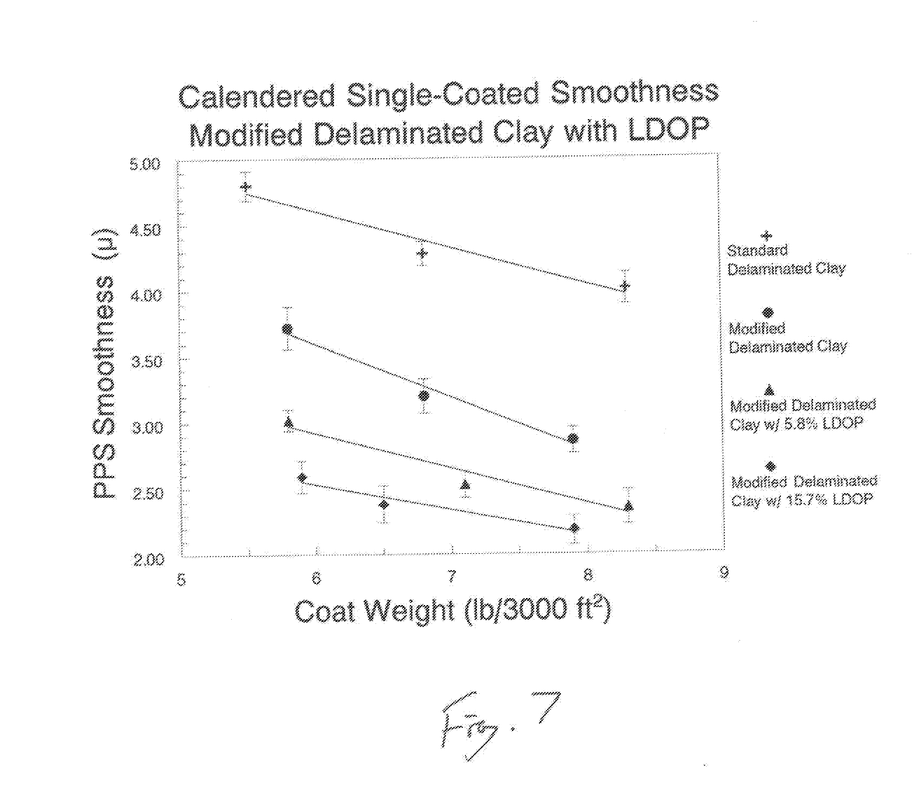

FIG. 7 shows the PPS smoothness data graphed as a function of coat weight. The results show that adding 25 to 50 parts by volume low density organic pigment reduced roughness by about 20-30 percent, and gave a decrease of 35-45 percent compared to standard delaminated clay. Achieving a PPS smoothness of less than 3.0 μm demonstrates that a sheet with an acceptable printing surface can be produced with a single coat that gives similar properties to commercially available double-coated products.

### Example 3

In another experiment, the coating compositions from Example 2 were used as basecoats and applied to the same paperboard substrate under the same conditions. These rolls of basecoated paperboard were then topcoated with a series of coat weights using a common topcoat formulation for all. The topcoat formulation is shown in Table 4.

TABLE 4

| | parts by |
|---|---|
| | weight |
| KAOFINE ™ | 30 |
| HYDROCARB ® 90 | 70 |
| ACRONAL ® S 504 | 12 |

The Parker Print Surf Smoothness was measured using the standard technique for both basecoat-only and topcoated samples, and the result are recorded in Tables 5A and 5B.

TABLE 5A

| | | | Calendered | |
|---|---|---|---|---|
| | | Coat | PPS | |
| | | Weight | Smoothness | Std. |
| | | lb/3000 ft² | (μm) | dev. |
| M1 | HYDRAPRINT ® | 5.5 | 5.77 | 0.15 |
| | | 6.8 | 5.11 | 0.19 |
| | | 8.3 | 4.84 | 0.15 |
| M2 | Modified | 5.8 | 4.34 | 0.16 |
| | HYDRAPRINT ® | 6.8 | 3.87 | 0.17 |
| | | 7.9 | 3.66 | 0.21 |
| M3 | Modified | 5.8 | 3.84 | 0.16 |
| | HYDRAPRINT ® | 7.1 | 3.33 | 0.13 |
| | w/25 parts by Vol. | 8.3 | 3.08 | 0.09 |
| M4 | Modified | 5.9 | 3.35 | 0.08 |
| | HYDRAPRINT ® | 6.5 | 3.19 | 0.24 |
| | w/50 parts by Vol. | 7.9 | 3.09 | 0.14 |

TABLE 5B

| | Basecoat | Topcoat | PPS | |
|---|---|---|---|---|
| Basecoat | Weight | Weight | Smoothness | Std. |
| Formulation | lb/3000 ft² | lb/3000 ft² | (μm) | dev. |
| M1 | 5.5 | 5.1 | 2.41 | 0.14 |
| M1 | 5.5 | 6.6 | 2.34 | 0.10 |
| M1 | 6.8 | 5.4 | 2.26 | 0.08 |
| M1 | 6.8 | 5.9 | 2.17 | 0.18 |
| M1 | 6.8 | 6.5 | 1.99 | 0.08 |
| M1 | 8.3 | 4.7 | 2.12 | 0.07 |
| M1 | 8.3 | 5.9 | 1.95 | 0.10 |
| M2 | 5.8 | 4.9 | 1.81 | 0.22 |
| M2 | 5.8 | 6.4 | 1.61 | 0.10 |
| M2 | 6.8 | 5.7 | 1.52 | 0.12 |
| M2 | 6.8 | 6.7 | 1.38 | 0.09 |
| M2 | 7.9 | 5.3 | 1.46 | 0.10 |
| M2 | 7.9 | 6.3 | 1.34 | 0.06 |
| M3 | 5.8 | 5.6 | 1.39 | 0.06 |
| M3 | 5.8 | 6.6 | 1.30 | 0.05 |
| M3 | 7.1 | 5.0 | 1.32 | 0.06 |
| M3 | 7.1 | 5.8 | 1.23 | 0.05 |
| M3 | 7.1 | 6.6 | 1.30 | 0.08 |
| M3 | 8.3 | 4.8 | 1.28 | 0.05 |
| M3 | 8.3 | 6.1 | 1.27 | 0.08 |
| M4 | 5.9 | 4.9 | 1.28 | 0.07 |
| M4 | 5.9 | 6.5 | 1.26 | 0.09 |
| M4 | 6.5 | 5.4 | 1.23 | 0.07 |
| M4 | 6.5 | 6.6 | 1.22 | 0.08 |
| M4 | 7.9 | 5.4 | 1.16 | 0.03 |
| M4 | 7.9 | 6.8 | 1.11 | 0.02 |

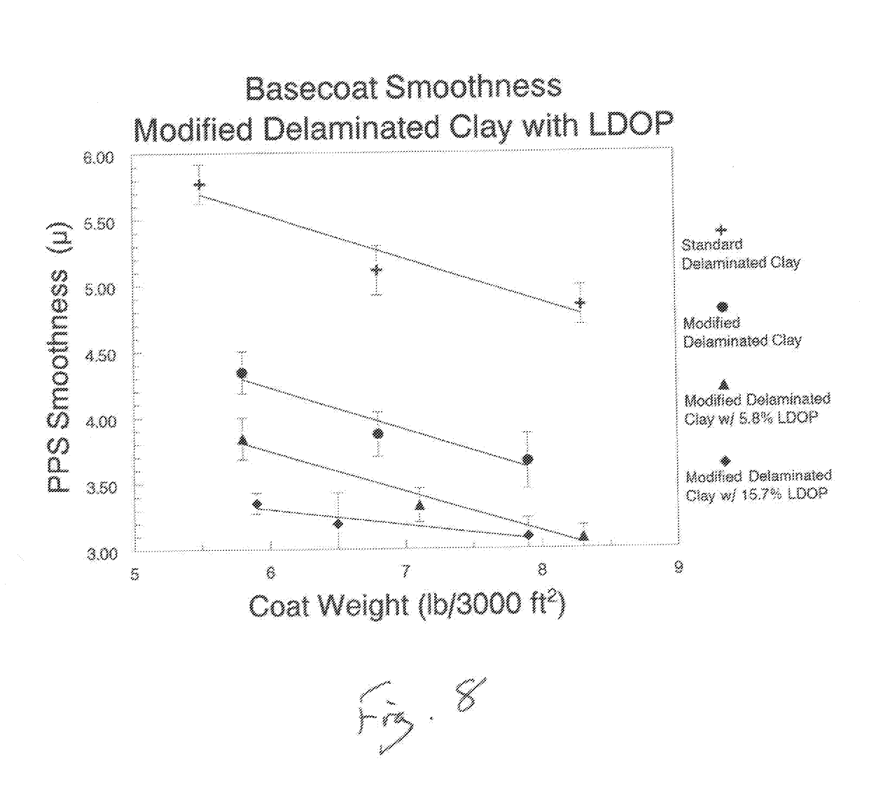

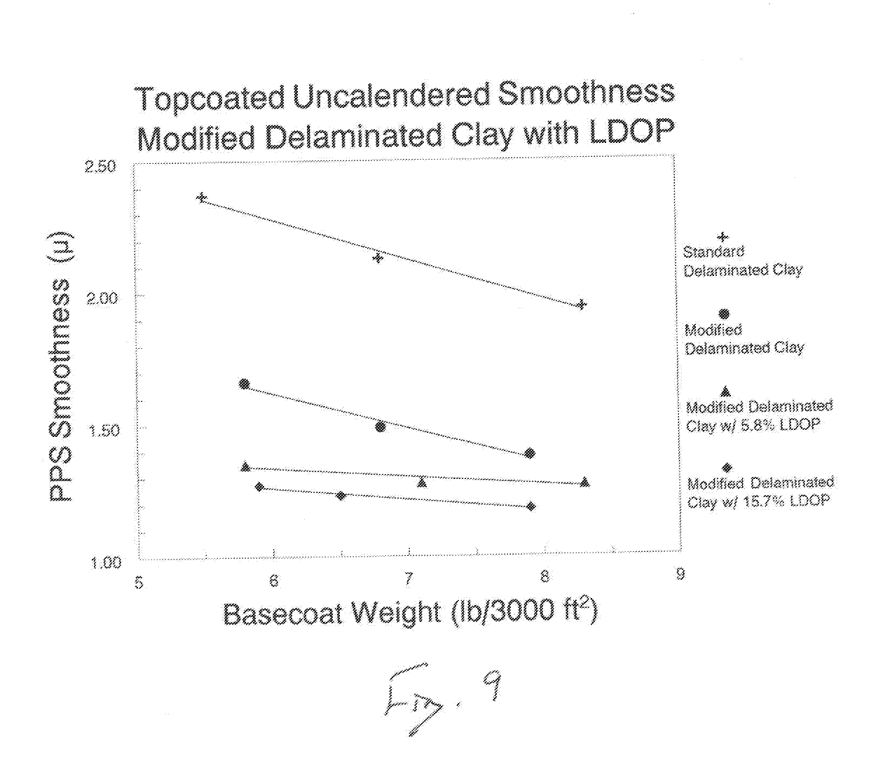

The basecoat-only results in FIG. 8 show a 15-25 percent decrease in roughness due to low density organic pigment addition. The topcoated data was used to obtain a regressed topcoated smoothness for a common coat weight of 6 lb/3000 ft². FIG. 9 shows those regressed topcoated smoothness values as a function of basecoat weight. The graphs show a reduction in roughness of 10-25 percent due to low density organic pigment addition, and a reduction of 35-45 percent compared to a standard delaminated clay.

### Example 4

Coatings compositions containing modified calcium carbonate and low density organic pigment were prepared and applied as a single-coat layer to a solid bleached sulfate (SBS) paperboard substrate (caliper: 11 pt; basis weight: 114 lb/3000 ft²). The coating compositions were applied to a 1 ft-wide web of the paperboard substrate at 1000 fpm using a bent blade configuration on a pilot coater, thereby obtaining coated samples with a series of coat weights. The coating compositions are presented in Table 6.

TABLE 6

| Parts by Weight | M5 | M6 | M7 | M8 |
|---|---|---|---|---|
| HYDROCARB ® 60 | 100 | | | |
| Modified HYDROCARB ® 60 | | 100 | 94.2 | 84.3 |
| ROPAQUE ™ 1353 | | | 5.8 | 15.7 |
| ACRONAL ® S 504 | 20 | 20 | 20 | 20 |
| Parts by Volume | M1 | M2 | M3 | M4 |
| HYDROCARB ® 60 | 100 | | | |
| Modified HYDROCARB ® 60 | | 100 | 75 | 50 |
| ROPAQUE ™ 1353 | | | 25 | 50 |

All coating compositions were formulated using only carbonate or a combination of carbonate and low density organic pigment. A standard coarse ground calcium carbonate, HYDROCARB® 60 from Omya, was used as a reference to the modified calcium carbonate (a processed version of HYDROCARB® 60 calcium carbonate; see FIG. 3). ROPAQUE™ 1353 from The Dow Chemical Company, was used as the low density organic pigment. The low density organic pigment was added to the modified calcium carbonate at levels representing 25 and 50 percent by volume. All formulations had 20 parts of ACRONAL® S504, a styrene acrylic latex, as binder.

Handsheets of coated board samples were supercalendered. The coat weights and the calendered PPS smoothness data is recorded in Table 7.

TABLE 7

| | | | Calendered | |
|---|---|---|---|---|
| | | Coat | PPS | |
| | | Weight | Smoothness | Std. |
| | | lb/3000 ft² | (μm) | dev. |
| M5 | HYDROCARB ® 60 | 5.1 | 5.38 | 0.17 |
| | | 5.9 | 5.09 | 0.26 |
| | | 7.0 | 4.00 | 0.17 |
| M6 | Modified | 5.8 | 4.34 | 0.12 |
| | HYDROCARB ® 60 | 6.8 | 3.88 | 0.13 |
| | | 7.8 | 3.44 | 0.11 |
| M7 | Modified | 6.6 | 3.53 | 0.10 |
| | HYDROCARB ® 60 | 7.6 | 3.22 | 0.12 |
| | w/25 parts by Vol. | 8.6 | 2.83 | 0.08 |
| M8 | Modified | 6.4 | 2.79 | 0.09 |
| | HYDROCARB ® 60 | 7.3 | 2.51 | 0.12 |
| | w/50 parts by Vol. | 7.5 | 2.41 | 0.09 |

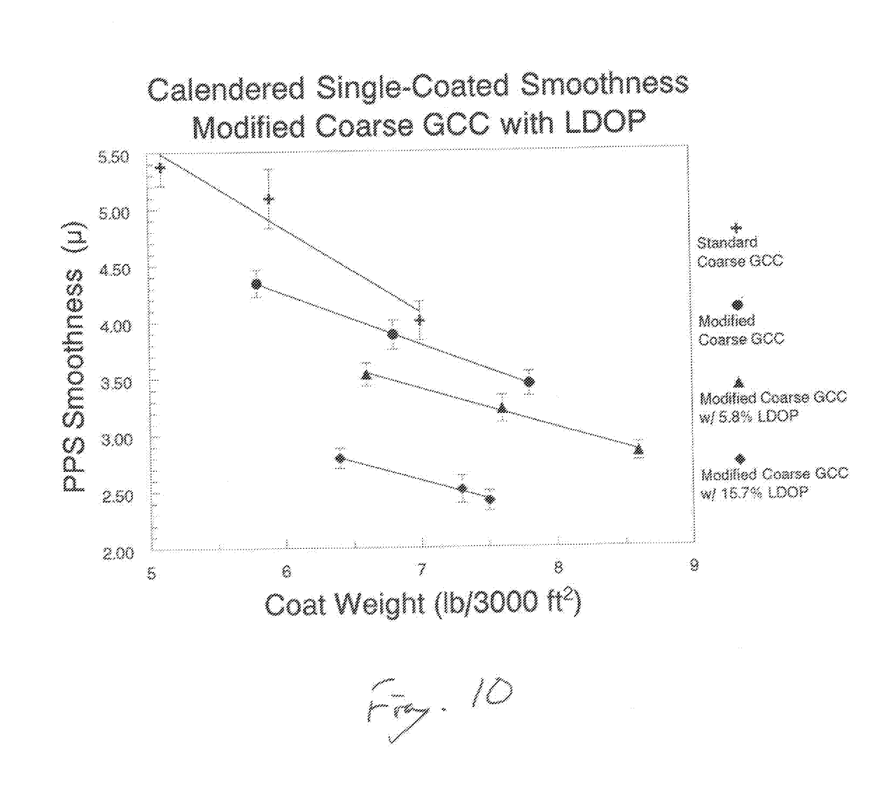

FIG. 10 shows the PPS smoothness data graphed as a function of coat weight. The results show that adding 25 to 50 parts by volume low density organic pigment reduced roughness by about 10-30 percent, and gave a decrease of 15-35 percent compared to standard coarse calcium carbonate. Achieving a PPS smoothness of less than 3.0 μm demonstrates that a sheet with an acceptable printing surface can be produced with a single coat that gives similar properties to commercially available double-coated products.

### Example 5

In another experiment, the coating compositions from Example 4 were used as basecoats and applied to the same paperboard substrate under the same conditions. These rolls of basecoated paperboard were then topcoated with a series of coat weights using a common topcoat formulation for all. The topcoat formulation is shown in Table 4.

The Parker Print Surf Smoothness was measured using the standard technique for both basecoat-only and topcoated samples, and the result are recorded in Tables 8A and 8B.

TABLE 8A

| | | Coat | PPS | |
|---|---|---|---|---|
| | | Weight | Smoothness | Std. |
| | | lb/3000 ft² | (μ) | dev. |
| M5 | HYDROCARB ® 60 | 5.1 | 6.17 | 0.15 |
| | | 5.9 | 5.86 | 0.20 |
| | | 7.0 | 5.69 | 0.15 |
| M6 | Modified | 5.8 | 5.18 | 0.16 |
| | HYDROCARB ® 60 | 6.8 | 4.65 | 0.11 |
| | | 7.8 | 4.16 | 0.12 |
| M7 | Modified | 6.6 | 4.38 | 0.18 |
| | HYDROCARB ® 60 | 7.6 | 3.60 | 0.13 |
| | w/25 parts by Vol. | 8.6 | 3.66 | 0.13 |
| M8 | Modified | 6.4 | 3.54 | 0.12 |
| | HYDROCARB ® 60 | 7.3 | 3.18 | 0.12 |
| | w/50 parts by Vol. | 7.5 | 3.20 | 0.14 |

TABLE 8B

| | Basecoat | Topcoat | PPS | |
|---|---|---|---|---|
| Basecoat | Weight | Weight | Smoothness | Std. |
| Formulation | lb/3000 ft² | lb/3000 ft² | (μm) | dev. |
| M5 | 5.1 | 5.0 | 2.71 | 0.11 |
| M5 | 5.1 | 5.8 | 2.73 | 0.14 |
| M5 | 5.1 | 6.6 | 2.61 | 0.16 |
| M5 | 5.9 | 5.1 | 2.77 | 0.14 |
| M5 | 5.9 | 6.4 | 2.56 | 0.14 |
| M5 | 7.0 | 5.5 | 2.35 | 0.09 |
| M5 | 7.0 | 6.8 | 2.28 | 0.07 |
| M6 | 5.8 | 5.2 | 2.23 | 0.12 |
| M6 | 5.8 | 6.1 | 2.04 | 0.13 |
| M6 | 6.8 | 5.2 | 1.87 | 0.12 |
| M6 | 6.8 | 6.6 | 1.82 | 0.13 |
| M6 | 7.8 | 5.3 | 1.72 | 0.11 |
| M6 | 7.8 | 6.5 | 1.67 | 0.17 |
| M7 | 6.6 | 4.9 | 1.74 | 0.11 |
| M7 | 6.6 | 5.8 | 1.61 | 0.12 |
| M7 | 6.6 | 6.9 | 1.58 | 0.06 |
| M7 | 7.6 | 4.9 | 1.55 | 0.13 |
| M7 | 7.6 | 6.7 | 1.45 | 0.06 |
| M7 | 8.6 | 4.9 | 1.54 | 0.14 |
| M7 | 8.6 | 5.8 | 1.43 | 0.15 |
| M8 | 6.4 | 5.4 | 1.32 | 0.13 |
| M8 | 6.4 | 6.3 | 1.23 | 0.05 |
| M8 | 7.3 | 4.9 | 1.27 | 0.09 |
| M8 | 7.3 | 5.7 | 1.24 | 0.12 |
| M8 | 7.5 | 5.6 | 1.20 | 0.05 |
| M8 | 7.5 | 6.7 | 1.11 | 0.03 |

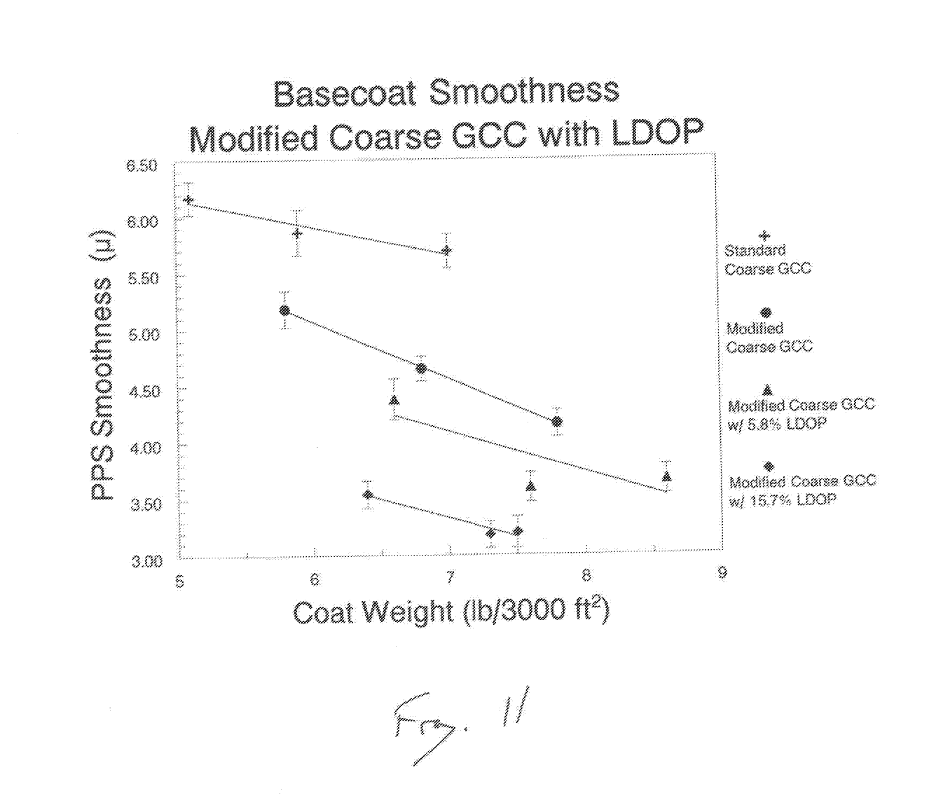

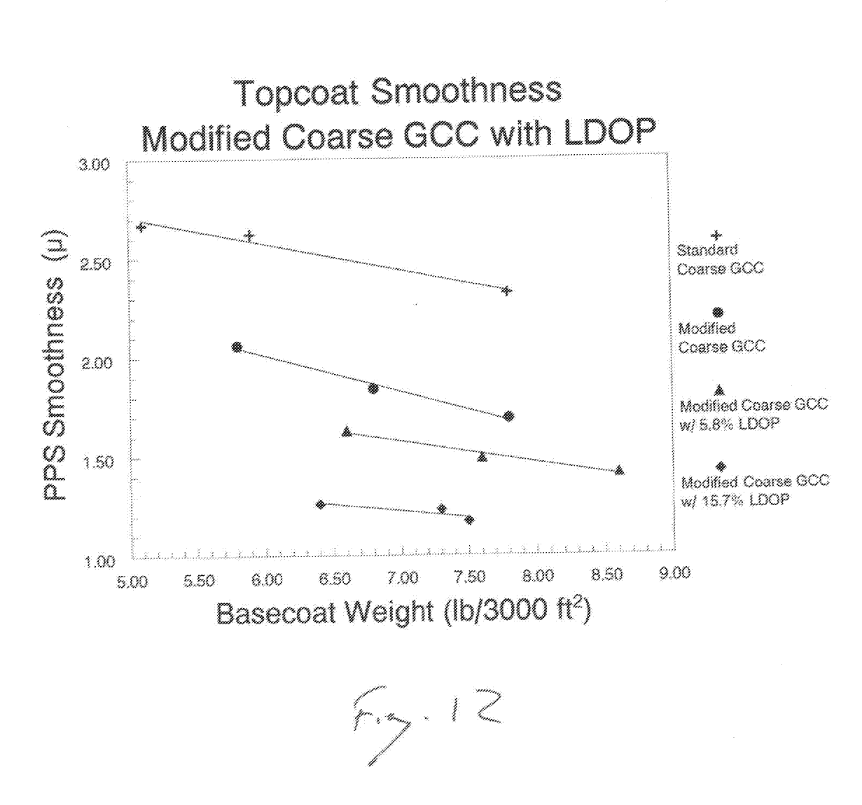

The basecoat-only results in FIG. 11 show a 10-25 percent decrease in roughness due to low density organic pigment addition, and a decrease of 30-40 percent compared to a standard coarse calcium carbonate. The topcoated data was used to obtain a regressed topcoated smoothness for a common coat weight of 6 lb/3000 ft². FIG. 12 shows those regressed topcoated smoothness values as a function of basecoat weight. The graphs show a reduction in roughness of 10-30 percent due to low density organic pigment addition, and a reduction of 35-50 percent compared to a standard coarse calcium carbonate.

Although various embodiments of the disclosed coating compositions and associated paperboard structures have been shown and described, modifications may occur to those skilled in the art upon reading the specification. The present application includes such modifications and is limited only by the scope of the claims.

What is claimed is:

1. A coating composition comprising:
a binder; and
a pigment blend comprising:
a low density organic pigment; and
a modified inorganic pigment.

2. The coating composition of claim 1 wherein said binder comprises latex.

3. The coating composition of claim 1 wherein said binder comprises starch.

4. The coating composition of claim 1 wherein said low density organic pigment comprises hollow spheres.

5. The coating composition of claim 1 wherein said low density organic pigment has a density of at most 1.04 g/cm³.

6. The coating composition of claim 1 wherein said low density organic pigment comprises spheres having an average diameter ranging from about 0.4 μm to about 1.5 μm.

7. The coating composition of claim 1 wherein said low density organic pigment comprises at least 15 percent by volume of said pigment blend.

8. The coating composition of claim 1 wherein said modified inorganic pigment comprises modified clay.

9. The coating composition of claim 8 wherein said modified clay comprises delaminated kaolin clay.

10. The coating composition of claim 8 wherein at most about 25 percent of said modified clay has a particle size less than 1 μm.

11. The coating composition of claim 1 wherein said modified inorganic pigment comprises modified calcium carbonate.

12. The coating composition of claim 11 wherein said modified calcium carbonate comprises coarse ground calcium carbonate.

13. The coating composition of claim 11 wherein at most about 12 percent of said modified calcium carbonate has a particle size less than 1 μm.

14. The coating composition of claim 1 wherein said modified inorganic pigment comprises modified calcium carbonate and modified clay.

15. The coating composition of claim 1 wherein said pigment blend further comprises an additional inorganic pigment.

16. The coating composition of claim 1 wherein said pigment blend has a void volume of at least 40 percent.

17. A paperboard structure comprising a paperboard substrate and said coating composition of claim 1 applied to said paperboard substrate.

18. A paperboard structure comprising:
a paperboard substrate, a basecoat and a top coat, wherein said basecoat is positioned between said paperboard substrate and said top coat, and
wherein said basecoat comprises a binder and a pigment blend including a low density organic pigment and a modified inorganic pigment.

19. A paperboard structure comprising:
a paperboard substrate and a single-coat layer applied to said paperboard substrate,
wherein said single-coat layer comprises a binder and a pigment blend including a low density organic pigment and a modified inorganic pigment.

20. The paperboard structure of claim 19 wherein said single-coat layer has a dry weight of at most about 9 pounds per 3000 square feet.
